(19) United States
(12) Patent Application Publication
(10) Pub. No.: US 2008/0139255 A1
(43) Pub. Date: Jun. 12, 2008

(54) Blue tooth hand free transmission assembly

(76) Inventors: Ching Yuan Wang, Taoyuan Hsien (TW); Ching huang Wang, Taoyuan Hsien (TW)

Correspondence Address: Ching Yuan Wang, 235 Chung-Ho, Box 8-24, Taipei, omitted

(21) Appl. No.: 11/636,268

(22) Filed: Dec. 11, 2006

(51) Int. Cl. H04M 1/00

(52) U.S. Cl. 455/569.2

(57) ABSTRACT

A blue tooth hand free transmission assembly, comprises a blue tooth mobile phone having blue tooth transmission function, a blue tooth hand free transmission device capable of being connected to the blue tooth mobile phone through blue tooth protocol; and sound and data from the blue tooth mobile phone being transferred through the blue tooth hand free transmission device wirelessly; and a car used stereo for receiving wireless signals and data from the blue tooth hand free transmission device; the sound being played through a trumpet and displayed on a display screen. The blue tooth hand free transmission assembly comprises a power input; a central processing unit for data processing; a blue tooth transmission unit capable of being connected to the blue tooth mobile phone through an antenna; and an electric wave transmission unit wirelessly connected to the car used stereo through an antenna.

### FIELD OF THE INVENTION

The present invention relates to blue tooth transmission, and particularly to a blue tooth hand free transmission assembly, wherein the blue tooth hand free transmission device is arranged between a blue tooth mobile phone and a car used stereo. The blue tooth hand free transmission device can be connected to the blue tooth mobile phone or the car used stereo. When the blue tooth mobile phone is connected to the car used stereo, the incoming call can be played from the car used stereo with a preferred sound quality and the cost is saved.

### BACKGROUND OF THE INVENTION

Due to the improvement of communication technology, mobile phones have become necessary devices in daily life. In driving a car, people often uses hand free mobile phones for safety consideration. However, the prior art hand free device is wired-connected to a mobile phone, but this is tedious and inconvenient. Thus, blue tooth mobile phones are developed so that an earphone is equipped to the users for wireless communication with the phone. If the user wears the earphone for a long time, the ear will feel uneasy. A blue tooth hand free device is developed, but it is not good in the audio transmission and is expensive.

### SUMMARY OF THE INVENTION

Accordingly, the primary object of the present invention is to provide a blue tooth hand free transmission assembly, wherein the blue tooth hand free transmission device of the present invention is arranged between a blue tooth mobile phone and a car used stereo. The blue tooth hand free transmission device can be connected to the blue tooth mobile phone or the car used stereo. When the blue tooth mobile phone is connected to the car used stereo, the incoming call can be played from the car used stereo with a preferred sound quality and the cost is saved.

Furthermore other than communication through the blue tooth mobile phone, the data can be displayed on the car used stereo through the car used stereo or a radio broadcast data system (RBDS). The data is for example, phone numbers of incoming calls, short messages, communication data, system states, etc. The transmission is wirelessly transmitted to the car used stereo. The audio emission is combined with data display so as to promote the functions of the car used stereo.

To achieve above objects, the present invention provides a blue tooth hand free transmission assembly, comprises a blue tooth mobile phone having blue tooth transmission function, a blue tooth hand free transmission device capable of being connected to the blue tooth mobile phone through blue tooth protocol; and sound and data from the blue tooth mobile phone being transferred through the blue tooth hand free transmission device wirelessly; and a car used stereo for receiving wireless signals and data from the blue tooth hand free transmission device; the sound being played through a trumpet and displayed on a display screen. The blue tooth hand free transmission assembly comprises a power input; a central processing unit for data processing; a blue tooth transmission unit capable of being connected to the blue tooth mobile phone through an antenna; and an electric wave transmission unit wirelessly connected to the car used stereo through an antenna.

The various objects and advantages of the present invention will be more readily understood from the following detailed description when read in conjunction with the appended drawing.

### BRIEF DESCRIPTION OF THE DRAWINGS

FIG. 1 is a schematic view showing the structure of the present invention.

FIG. 2 is a circuit block diagram of the present invention.

FIG. 3 shows the outlook of the present invention.

FIG. 4 is a schematic view showing that the present invention is connected to an audio source.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

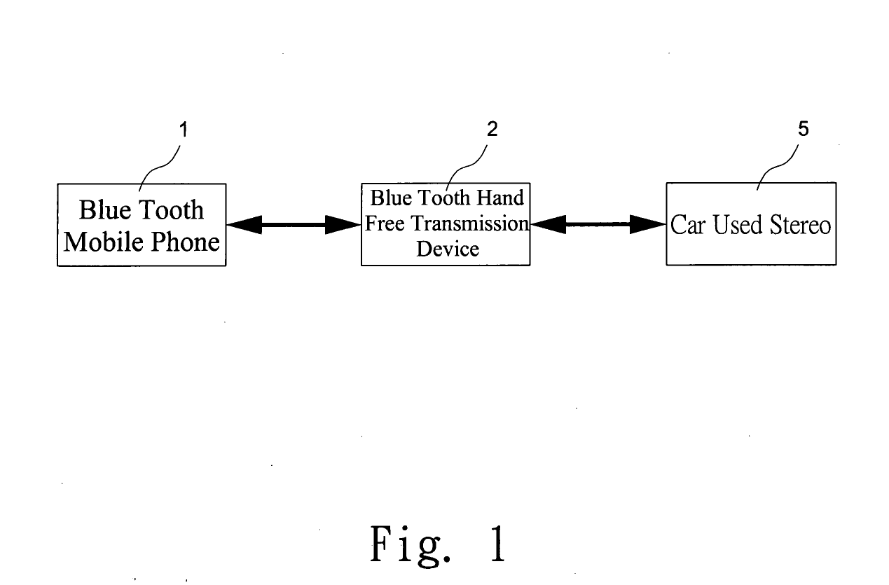

With reference to FIG. 1, the blue tooth hand free transmission device 2 of the present invention is arranged between a blue tooth mobile phone 1 and a car used stereo 5.

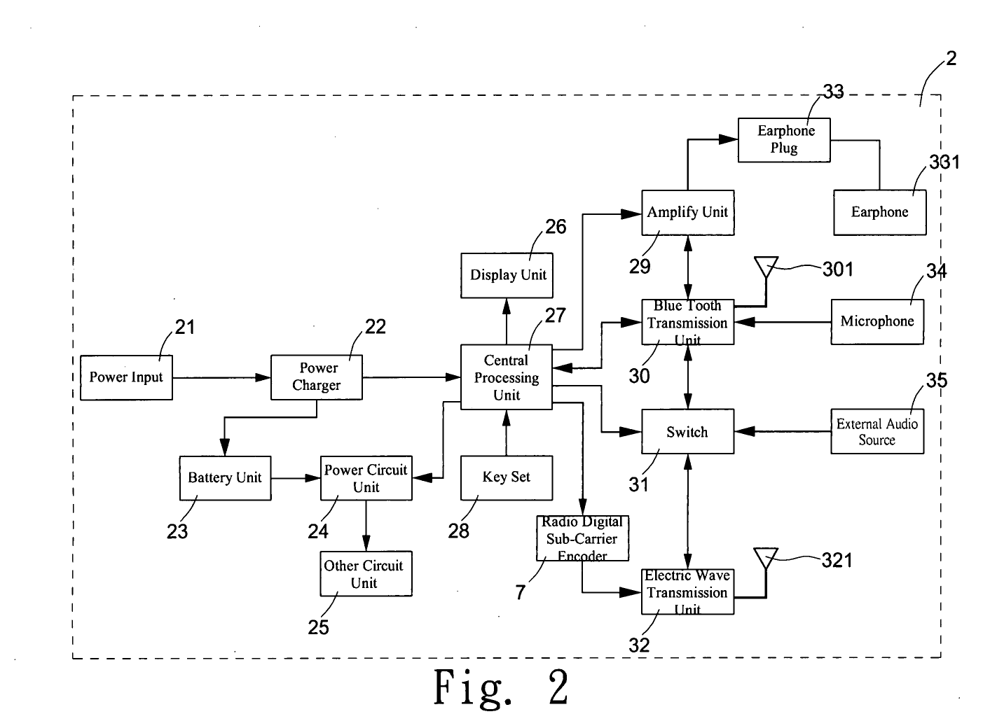

Referring to FIG. 2, the blue tooth hand free transmission device 2 of the present invention comprises the following elements.

A power input 21 is capable of being inserted into an igniter within a car for getting power. The power input 21 is connected to a power charger 22 for charging power from the power input 21. The power is stored in a battery unit 23. The power circuit unit 24 is connected to the battery unit 23 for supplying electric power to the circuit unit 25.

A display unit 26 serves to display various information, such as incoming call numbers, or the state about the applications.

A central processing unit 27 serves for processing various data.

A key set 28 serves for controlling and switching.

An amplify unit 29 serves for amplifying the audio signals. The amplify unit 29 can be connected to an earphone plug 33 and then is further connected to an earphone 331.

A blue tooth transmission unit 30 serves to be connected to the blue tooth mobile phone 1 through an antenna 301 and the blue tooth transmission unit 30 is further arranged with a microphone 34.

A switch 31 is connected to an external audio source 35 and can switch the external audio source 35.

An electric wave transmission unit 32 is wirelessly connected to a car used stereo 5 through an antenna 321 by such as FM modulation.

By above mentioned structure, when the blue tooth hand free transmission device 2 of the present invention is installed in a car, it is only necessary to plug the power input 21 to an igniter of the car without any other wiring. In use, the user must adjust the frequency band of the blue tooth hand free transmission device 2 to match to the frequency band of the car used stereo 5, that is, to adjust the frequency band of the electric wave transmission unit 32 to the frequency band of the car used stereo 5. When an incoming call of a mobile phone occurs, the blue tooth mobile phone 1 is connected to the blue tooth hand free transmission device 2 through the blue tooth transmission unit 30. The incoming sounds are emitted through the electric wave transmission unit 32 and is received by the car used stereo 5. Then the sounds are played through the trumpet of the car used stereo 5. Thus a hand free function is achieved. The phone number of the incoming call is sent to a radio digital sub-carrier encoder 7 through the central processing unit 27. Then it is transmitted by the electric wave transmission unit 32 to the car used stereo 5 and then is displayed on the display. Thus the use can read the related information. If there is other passenger in the car in communication and thus the user hopes that the sound is not played through the car used stereo 5 so as to keep privacy. The key set 28 can be set to make the sound only transmits to the earphone or a phone receiver.

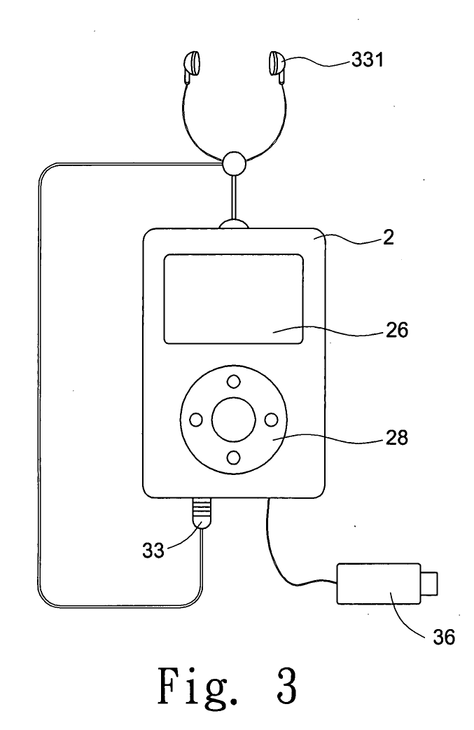

Referring to FIG. 3, an outlook of the blue tooth hand free transmission device 2 of the present invention is illustrated. The blue tooth hand free transmission device 2 has a display unit 26 and a key set 28. Furthermore an USB joint 36 is also included. The present invention can be used with earphone 331 through an earphone plug 33.

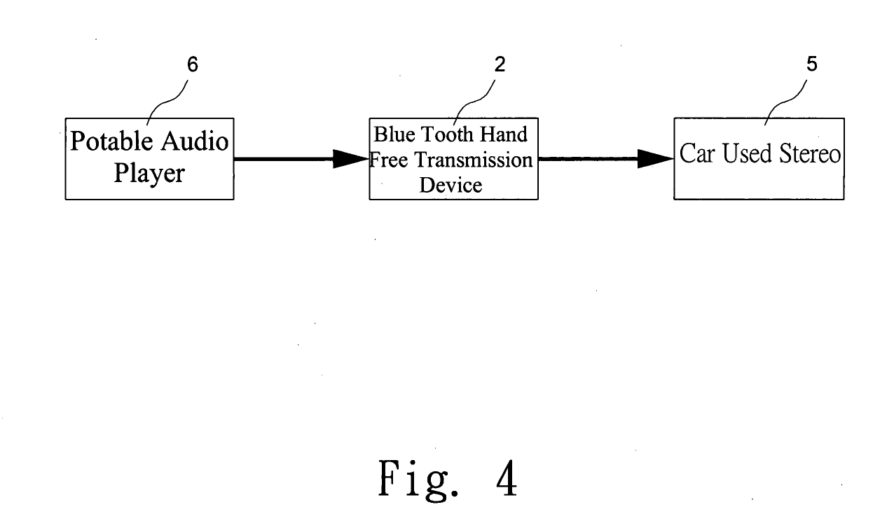

Since the car used stereo 5 of an old type car has only the function of audio player or a CD player without the function of MP3. Referring to FIGS. 2 to 4, the present invention further has a function of external audio source 35 which can be connected to a potable audio player 6 of any form and then the sound is transferred to the car used stereo 5. Therefore, the car used stereo 5 is promoted.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A blue tooth hand free transmission assembly, comprising:
a blue tooth mobile phone having blue tooth transmission function,
a blue tooth hand free transmission device capable of being connected to the blue tooth mobile phone through blue tooth protocol; and sound and data from the blue tooth mobile phone being transferred through the blue tooth hand free transmission device wirelessly; and
a car used stereo for receiving wireless signals and data from the blue tooth hand free transmission device; the sound being played through a trumpet and displayed on a display screen.

2. The blue tooth hand free transmission assembly, as claimed in claim 1, wherein the blue tooth hand free transmission assembly comprising:
a power input;
a central processing unit for data processing;
a blue tooth transmission unit capable of being connected to the blue tooth mobile phone through an antenna; and
an electric wave transmission unit wirelessly connected to the car used stereo through an antenna.

3. The blue tooth hand free transmission assembly as claimed in claim 1, wherein the power input is capable of being inserted into an igniter within a car for getting power; the power input is connected to a power charger for charging power from the power input; the power is stored in a battery unit; and the power circuit unit is connected to the battery unit for supplying electric power to the circuit unit.

4. The blue tooth hand free transmission assembly as claimed in claim 2, wherein the blue tooth hand free transmission device comprises:
a key set for controlling and switching;
an amplify unit for amplifying the audio signals; the amplify unit being connected to an earphone plug and then connected to an earphone; and
a switch connected to an external audio source and can switch the external audio source.

5. The blue tooth hand free transmission assembly as claimed in claim 2, wherein the blue tooth transmission unit is installed with a microphone.

6. The blue tooth hand free transmission assembly as claimed in claim 4, wherein the external audio source is a portable audio player.

7. The blue tooth hand free transmission assembly as claimed in claim 1, wherein the wireless transmission includes FM modulation and radio digital sub-carrier.

8. The blue tooth hand free transmission assembly as claimed in claim 1, wherein the blue tooth hand free transmission device further comprises a radio digital sub-carrier (RDS) encoder.
